(19) United States
(12) Patent Application Publication
(10) Pub. No.: US 2009/0165615 A1
(43) Pub. Date: Jul. 2, 2009

(54) Table saws

(75) Inventors: Takeshi Nishimiya, Anjo-shi (JP); Hidekazu Suda, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, ANJO-SHI (JP)

(21) Appl. No.: 12/318,323

(22) Filed: Dec. 24, 2008

(30) Foreign Application Priority Data
Dec. 28, 2007 (JP) 2007-339465

(51) Int. Cl. B26D 5/00; B27B 5/29; B23D 45/06

(52) U.S. Cl. 83/61; 83/477.2; 83/62.1; 83/522.12

(57) ABSTRACT

A table saw 10 includes a table 14 supported on a mount base 12, and a saw blade 25 rotated by a motor 22 and protruding upwardly from the table 14, so that a workpiece can be cut by the saw blade 25 as it is slidably moved on the table 14. In addition, the table saw 10 includes a cutting condition detection device for determining whether or not the workpiece is being cut, a vibration sensor 30 for detecting an acceleration of vibration, and a motor stopping device for stopping the motor 22 when the acceleration of the vibration detected by the vibration sensor 30 exceeds an acceptable value.

This application claims priority to Japanese patent application serial number 2007-339465, the contents of which are incorporated herein by reference.

### BACKGROUND OF INVENTION

1. Field of the Invention

The present invention relates to table saws that include a table supported on a mount base, and a disk-like saw blade rotatably driven by a motor, so that a workpiece, which is slidably moved on the table, is cut by the saw blade protruding upwardly from the table.

2. Description of the Related Art

A known table saw is disclosed in, for example, Japanese Laid-Open Patent Publication No. H11-010606. When an excessive load is applied to a motor or a saw blade, a table saw generates a heavier vibration than usual. Such an excessive load to the motor or the saw blade may be caused by, for example, cutting a plate forcedly moved toward the saw blade, cutting a gnarl or the like of said plate, or placing the table saw on an uneven place. However, the known table saw does not have any mechanism for stopping the motor when a heavier vibration than usual is generated during cutting operation.

Therefore, there has been a need for table saws that include a mechanism for automatically stopping the motor when the beaver vibration than usual is generated, thereby improving safety of the table saw.

### SUMMARY OF THE INVENTION

One aspect according the present invention includes a table saw including a table supported on a mount base and a saw blade rotated by a motor such that the disk saw blade cut a workpiece as the workpiece slidably moves on the table. The table saw has a cutting condition detection device for determining whether or not the workpiece is being cut, and a vibration sensor for detecting vibration, and a motor stopping device for stopping the motor when the acceleration of the vibration detected by the detection device exceeds an acceptable value during cutting the workpiece.

In accordance with the present invention, the table saw has the vibration sensor, and thus can detect the vibration generated during cutting the workpiece by the vibration sensor. If cutting of the workpiece is detected by the cutting condition detection device, and the acceleration of the vibration detected by the vibration sensor exceeds the acceptable value, the motor stopping device stops the motor. That is, when the heavier vibration than usual is generated due to an excessive load applied to the motor or the saw blade, the motor can be stopped immediately, thereby improving safety of the table saw. In addition, the motor stopping device operates when the cutting of the workpiece is determined by the cutting condition detection device, and the acceleration of the vibration exceeds the acceptable value, and thus the motor stopping device does not work when, e.g., the acceleration of the vibration is beyond the acceptable range by roughly putting the workpiece on the table.

In one embodiment, the vibration sensor is mounted on a back surface of the table and/or an upper portion of the mount base parallel to the table. Accordingly, the vibration sensor can efficiently detect vibration of the table saw.

In another embodiment, the cutting condition is determined based on the rotation number of the motor and/or the amount of the load current of the motor. Accordingly, the cutting condition detection device can detect a cutting operation.

In a further embodiment, the table saw further includes a brake operable to stop the motor when an acceleration of the vibration detected by the vibration sensor exceeds a predetermined value during the cutting operation of the workpiece. Accordingly, such motor stopping device can stop the motor.

### BRIEF DESCRIPTION OF THE DRAWINGS

FIG. 1 is a plane view of the table saw according to an embodiment of the present invention;

FIG. 2 is a front view of the table saw shown in FIG. 1;

FIG. 3 is a vertical sectional view of the table saw shown in FIG. 1;

FIG. 4 is a perspective view of the table saw from bottom side;

FIG. 5 is an electric circuit diagram of the table saw, and

FIG. 6 is a flowchart showing a behavior of the table saw.

### DETAILED DESCRIPTION OF THE INVENTION

Each of the additional features and teachings disclosed above and below may be utilized separately or in conjunction with other features and teachings to provide improved table saws. Representative examples of the present invention, which examples utilized many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### First Representative Embodiment

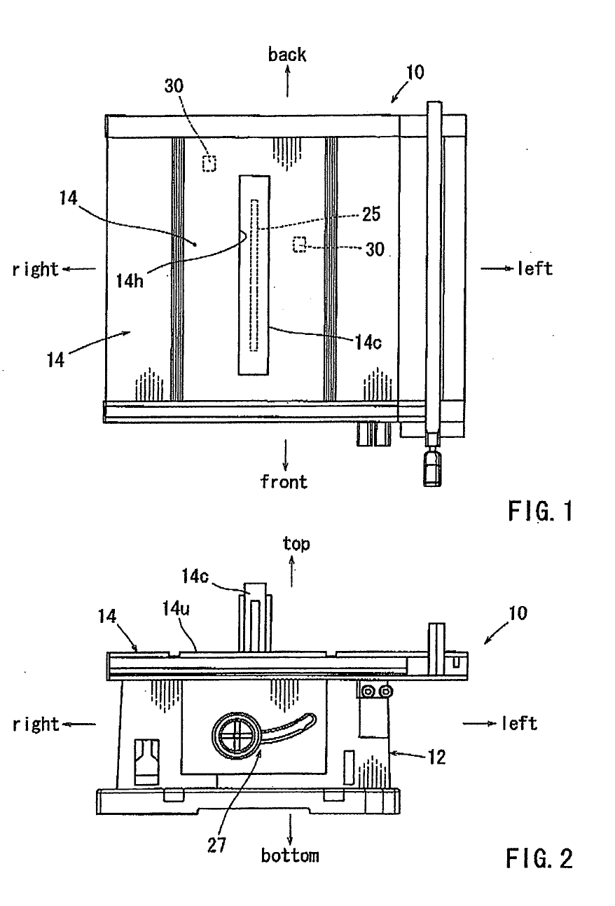

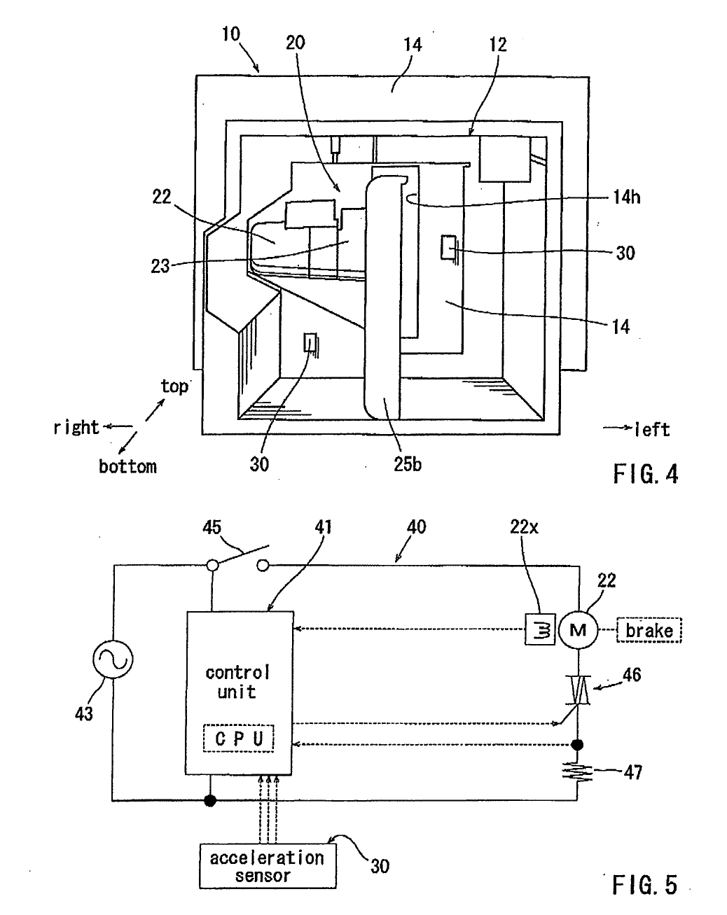

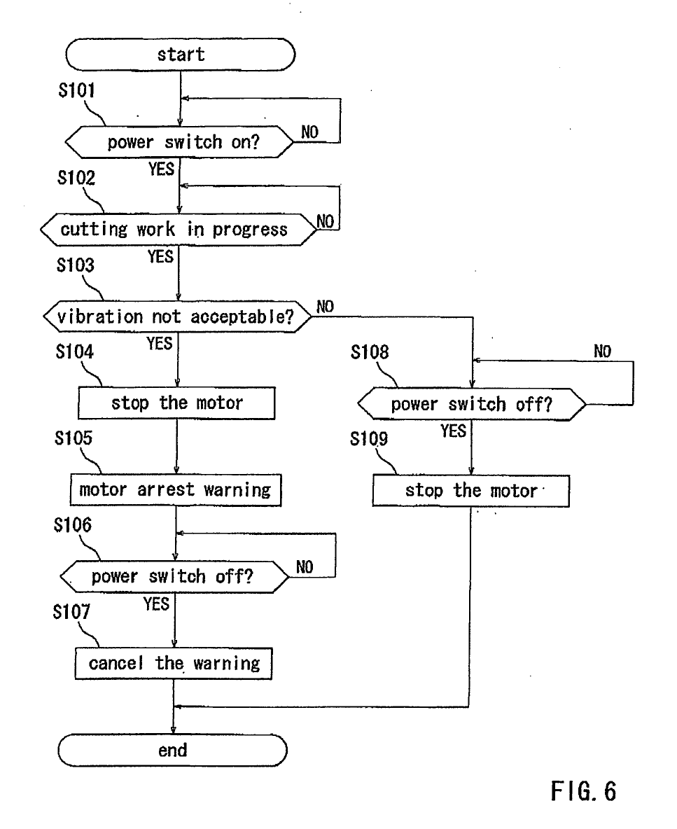

A table saw according to a first embodiment will be described in reference to FIGS. 1-6. FIGS. 1-3 are a plan view, a front view and a vertical section view of a table saw, respectively, and FIG. 4 is a perspective view of a table saw as viewed from a bottom side. In addition, FIGS. 5 and 6 are an electric circuit diagram of a table saw and a flowchart showing a behavior of a table saw, respectively. The labels “front”, “back”, “right”, “left”, “top” and “bottom” in Figures correspond to front, back, right, left, top and bottom sides of the table saw, respectively.

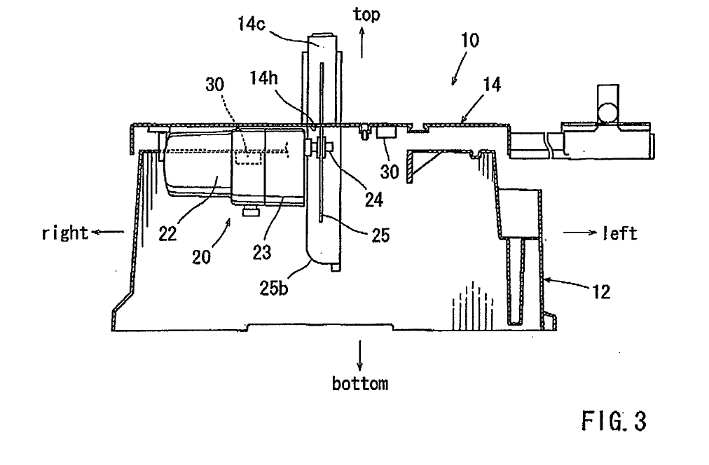

A table saw 10 is an power tool for cutting a workpiece (such as a plate) by a disk-like saw blade 25, and can include a hollow mount base 12, a table 14 having a rectangular configuration in plan view and disposed horizontally on the mount base 12, and a drive unit 20 for the saw blade 25 as shown in FIG. 2. The mount base 12 can be formed in a rectangular shape in plan view and formed in a substantially trapezoidal shape in side view. The drive unit 20 is housed in the mount base 12, and has a motor 22 mounted on the center of the back surface of the table 14 and extending horizontally as shown in FIGS. 3 and 4. The table saw 10 is configured such that the torque of the motor 22 is transmitted to a spindle 24 via a reduction system 23. The spindle 24 is disposed parallel to the axis of rotation (not shown) of the motor 22, and the disk-like saw blade 25 is attached to the spindle 24 concentrically therewith. A part of the saw blade 25 protrudes upwardly through an opening 14h formed in the table 14. Furthermore, a part of the saw blade 25 protruding through the opening 14h is covered by a safety cover 14c, which is not depicted in FIG. 1.

In addition, the table saw 10 can include an adjusting system (not shown), which can adjust the inclination of the saw blade 25 relative to a table surf-ace 14u, on the back surface of the table 14. A handle 27 of the adjusting system is provided on the front surface of the mount base 12 as shown in FIG. 2. The adjusting system (except the handle 27) and the saw blade 25 are covered by a saw blade cover 25b as shown in FIGS. 3 and 4.

The table saw 10 includes a vibration sensor 30 for detecting vibration of the table 14 or the mount base 12 when cutting the workpiece such as a plate. The vibration sensor 30 detects acceleration of the vibration in x-axis (crosswise direction), y-axis (longitudinal direction), and z-axis (vertical direction), and is mounted near the saw blade 25 or the motor 22. FIGS. 1, 3 and 4 show two vibration sensors 30, one of which is positioned near the saw blade 25 on the back surface of the table 14, and the other of which is positioned near the motor 22 and on the upper portion of the mount base 12 parallel to the table 14. However, the vibration sensor 30 can be attached to either the upper portion of the mount base 12 or the back surface of the table 14.

FIG. 5 shows a schematic electric circuit 40 for the table saw 10 including the vibration sensor 30 (acceleration sensor). A signal from the vibration sensor 30 is transmitted to a control unit 41 of the table saw 10, which is a part of the electric circuit 40 in FIG. 5. The control unit 41 includes a CPU (or the like) for controlling operation of the electric circuit 40. The electric circuit 40 is a circuit for driving the motor 22 due to AC source 43, and has the control unit 41, a power switch 45, a bi-directional thyistor (triac) 46, and a shunt resistor 47. The control unit 41 regulates an output power from the motor 22 by phase controlling a gate signal of the bi-directional thyristor 46. The control unit 41 receives a revolution number signal from a rotation sensor 22× and a voltage signal from the shunt resistor 47 for detecting a load current on the motor 22. When the revolution number of the motor is within a predetermined range or when the amount of the load current on the motor 22 exceeds a defined value, the control unit 41 determines that the saw blade 25 is cutting the plate. In addition, when the acceleration of the vibration detected by the vibration sensor 30 during cutting the plate exceeds an acceptable value over a predetermined period (for example, about 0.5 second), the control unit 41 outputs a signal for stopping the motor 22. That is, the shunt resistor 47, the rotation sensor 22× and the control unit 41 constitute a cutting condition detection device, and the control unit 41 and the bi-directional thyristor 46, etc. constitute a motor stopping device, which stops the supply of electric power to the motor 22.

The control process of the table saw 10 will be described in reference to the flow chart in FIG. 6. First, when the power switch 45 is turned on (i.e., the determination in Step S101 is YES), the control unit 41 outputs the gate signal to the bi-directional thyristor 46. Then, the motor 22 starts to rotate the saw blades 25, so that the table saw 10 is ready to cut the plate. If the plate is being out by the table saw 10, the load current on the motor 22 increases and the revolution of the motor 22 decreases, and thus it is possible to determine that the cutting operation is being performed based on a signal from the rotation sensor 22× or a voltage signal from the shunt resistor 47. It is also possible to determining the cutting operation based on both the load current and the revolution of the motor 22.

When an accelerated vibration is generated due to application of an excessive load on the motor 22 or the saw blade 25 during the cutting operation and the acceleration of the vibration of the table 14 or other parts exceeds the acceptable value over the predetermined period (for example, about 0.5 second) (i.e., when the determination in Step S103 is YES), the control unit 41 outputs a signal to the bi-directional thyristor 46 for stopping the motor 22. That is, when a heavier vibration than usual is generated, the motor 22 is stopped immediately. Then, the control unit 41 operates a lamp and/or a bier (not shown) for giving a motor arrest alarm (Step S105). When the operator turns the power switch 45 off (i.e., when the determination in Step S106 is YES) after the stop of the motor 22, the alarm is reset, the lamp for alerting attest of the motor is turned off, and the buzzer is stopped. On the other hand, if the heavier vibration than usual is not generated during the cutting operation (i.e., if the determination in Step S103 is NO), the motor is stopped (Step S109) by the operation for turning the power switch 45 off (the determination in Step S108 is YES).

By implementing the vibration sensor 30, vibration generated during cutting the plate can be detected. And, when the heavier vibration than usual is generated and the acceleration of the vibration detected by the vibration sensor exceeds the acceptable value, the motor is stopped by the operations of the control unit 41 and the bi-directional thyristor 46 (motor stopping device). That is, when the heavier vibration is generated due to the excessive load applied to the motor 22 or the saw blade 25, the motor 22 can be stopped immediately, thereby improving the safety of the table saw 10. In addition, the table saw 10 is configured such that the shunt resistor 47, the rotation sensor 22× and the control unit 41 (cutting condition detection device) determines that the saw blade 25 is cuffing the plate, and such that the motor 22 is stopped when the acceleration of the vibration exceeds the acceptable value. Accordingly, when the acceleration exceeds the acceptable value by, for example, roughly putting the plate on the table 14, the motor 22 is not stopped. Further, the vibration sensor 30 can be mounted on the back surface of the table 14 and/or on the upper portion of the mount base 12 parallel to the table 14, and thus can detect the vibration of the table saw 10 efficiently. In addition, the cutting operation can be certainly determined based on the revolution and/or the load current on the motor 22.

The present invention is not limited to the above embodiment, but can be modified without departing from the scope of the invention. For example, although the vibration sensor 30 is mounted on the back surface of the table 14 and/or the upper portion of the mount base 12 parallel to the table 14 in the above embodiment, the vibration sensor 30 can be attached to the housing of the motor 22. In addition, although the vibration sensor 30 detects the acceleration of the vibration in the embodiment, the vibration sensor 30 can be configured to detect other characteristics of vibration such as amplitude or frequency of vibration. Furthermore, the motor stopping device can be configured to stop the motor depending on the detected characteristics e.g. acceleration, amplitude, frequency and/or combination thereof during a predetermined period of time. Although the motor 22 is stopped by the gating signal transmitted from the control unit 41 to the bi-directional thyristor 46 in the above embodiment, it is possible to also use a brake in order to stop the motor 22. If a motor equipped with a brake is used, the control unit 41 outputs a signal for stopping the motor to the bi-directional thyristor 46, and then outputs a signal to operate the brake. Due to these configurations, the motor 22 can be stopped more immediately.

1. A table saw, comprising
a table supported on a mount base,
a saw blade protruding upwardly through the table for cutting a workpiece as the workpiece slidably moves on the table,
a motor for rotating the saw blade,
a cutting condition detection device configured to be able to determine whether or not the workpiece is being cut,
a vibration sensor configured to detect vibration,
a motor stopping device operable to stop the motor when an acceleration of the vibration detected by the vibration sensor exceeds a predetermined value during the cutting operation of the workpiece.

2. The table saw as defined in claim 1, wherein the vibration sensor is positioned on a back surface of the table.

3. The table saw as defined in claim 1, wherein the vibration sensor is positioned on an upper portion of the mount base, which extends substantially parallel to the table.

4. The table saw as defined in claim 1, wherein the cutting condition detection device determines whether or not the workpiece is being cut based on a revolution of the motor.

5. The table saw as defined in claim 1, wherein the cutting condition detection device determines whether or not the workpiece is being cut based on an amount of load current applied to the motor.

6. The table saw as defined in claim 1, wherein the motor stopping device comprises a brake operable to stop the motor, and a device operable to stop the supply of power to the motor when an acceleration of the vibration detected by the vibration sensor exceeds a predetermined value during the cutting operation of the workpiece.

7. A table saw comprising:
a table;
a saw blade;
an electric motor constructed to rotatably drive the saw blade, so that a workpiece placed on the table can be cut by the saw blade;
a vibration sensor operable to detect vibration applied to the table saw;
a motor stopping device operable to stop the motor when an acceleration of the vibration applied to the table saw has exceeded a predetermined value.

8. The table saw as in claim 7, further comprising a cutting condition detection device operable to determine whether or not the workpiece is being cut, and the motor stopping device is configured to stop the rotor when the cutting operation determining device determines that the workpiece is being cut.

9. The table saw as in claim 8, wherein the determination by the cutting condition detection device is made based on at least one of a current load applied to the motor and a rotational speed of the motor.

10. The table saw as in claim 7, wherein the motor stopping device comprises a controller that can stop the supply of power to the motor.

11. The table saw as in claim 7, wherein the motor stopping device comprises a brake that can apply a braking force to the motor.

12. The table saw as in claim 7, further comprising an alert device operable to give an alert when the motor has stopped.

13. The table saw as in claim 7, wherein the motor stopping device is operable to stop the motor when an acceleration of the vibration applied to the table saw has exceeded the predetermined value during a predetermined period of time.

14. A table saw, comprising
a table supported on a mount base,
a saw blade protruding upwardly through the table for cutting a workpiece as the workpiece slidably moves on the table,
a motor for rotating the saw blade,
a cutting condition detection device configured to be able to determine whether or not the workpiece is being cut,
a vibration sensor configured to detect vibration,
a motor stopping device operable to stop the motor depending on characteristics of vibration detected by the vibration sensor during the cutting operation of the workpiece.

15. The table saw as in claim 14, wherein the characteristics of vibration is selected from a group constituting of acceleration, frequency and amplitude of vibration and combination thereof.
